(19) United States
(12) Patent Application Publication
(10) Pub. No.: US 2016/0114477 A1
(43) Pub. Date: Apr. 28, 2016

(54) TELESCOPIC MAGNETIC RETRIEVAL DEVICE

(71) Applicant: Asia Connection LLC, New York, NY (US)

(72) Inventors: Mitch Saccoccio, Clarksville, VA (US); Jonathan Bonelli, New York, NY (US)

(21) Appl. No.: 14/921,373

(22) Filed: Oct. 23, 2015

Related U.S. Application Data
(60) Provisional application No. 62/067,604, filed on Oct. 23, 2014.

(51) Int. Cl. B25J 1/04; B25J 15/06

(52) U.S. Cl. CPC B25J 1/04; B25J 15/0608

(57) ABSTRACT

A retrieval device is disclosed that includes a rod having a distal end and a proximal end, and a magnet attached to the distal end of the rod to magnetically attract debris and other objects. The magnet may be attached to a cover on the distal end of the rod via a recess within the cover. The magnet may be positioned at multiple positions within the recess. When the magnet is positioned at a bottom of the recess, the recess forms an empty space formed by the cover, thereby encasing any debris or objects that are captured within the recess of the cover.

### CROSS-REFERENCE TO RELATED APPLICATIONS

This application claims priority to U.S. Provisional Application No. 62/067,604, filed Oct. 23, 2014, the entire disclosure of which is hereby incorporated herein by reference.

### FIELD OF INVENTION

The present application generally relates to a device for retrieving debris using a magnetic field.

### BACKGROUND OF THE INVENTION

Devices used to retrieve debris from difficult to reach locations or used to retrieve debris that is too small for effective retrieval with human hands often require precise hand-to-eye coordination. For example, devices having a mechanical grip at a distal end and a control means at a proximal end generally require that the mechanical grip be placed on the debris with precision in order to grip the debris and retrieve it. In other retrieval devices it is a sharp end that is often used to puncture the debris and retrieve it. However, these devices require precise hand-to-eye coordination in order to puncture a small piece of debris that is already in a difficult place to reach. Accordingly, there remains a need for a device that can be used to retrieve debris from hard to reach places or places where proper hand-to-eye coordination is not possible.

### SUMMARY OF THE INVENTION

The present disclosure provides a device that is able to retrieve debris disposed within a difficult to reach location even where hand-to-eye coordination may be obstructed. For example, hand-to-eye coordination may be obstructed in a fluid where vision is impaired, such as a container or body of water, oil, or the like. Alternatively, the device may be used to reach into locations that are beyond vision and/or physical reach capture debris disposed therein.

Accordingly, a magnetic retrieval device is provided herein. The magnetic retrieval device includes a rod having a distal end and a proximal end; and a magnet attached to the distal end of the rod.

A retrieval device to clean debris in a pool is also provided herein, wherein the retrieval device includes a distal end and a proximal end; a cover attached to the distal end of the rod; and a fastening means for attaching a magnet to the cover.

### BRIEF DESCRIPTION OF THE FIGURES

FIG. 1 is a perspective view of a magnetic retrieval device in accordance with aspects of the disclosure;

FIG. 2 is an exploded view of the magnetic retrieval device in accordance with aspects of the disclosure;

FIG. 3 is a cross-sectional view of a rod and cover of the magnetic retrieval device in accordance with aspects of the disclosure

FIG. 4 is a side view of the cover attached to the rod in accordance with aspects of the disclosure; and

FIGS. 5A-B depict a magnet in relation to the cover and rod in accordance with aspects of the disclosure.

Like reference numerals indicate similar parts throughout the figures.

### DESCRIPTION OF PREFERRED EMBODIMENTS OF THE INVENTION

The present disclosure may be understood more readily by reference to the following detailed description of the disclosure taken in connection with the accompanying figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Reference will now be made in detail to the exemplary embodiments of the present disclosure, which are illustrated in the accompanying drawings.

In the first aspect of the invention, a magnetic retrieval device is disclosed. The magnetic retrieval device, in one embodiment, comprises a longitudinal rod, a magnetic, and a coupling mechanism to couple the magnet to the rod. The magnet is attached to a distal end of the rod while a user holds a proximal end of the rod. By holding the proximal end of the rod, the user may navigate the magnet on the distal end of the rod to pick-up various debris. The debris may be, for example, in a swimming pool, pond, or perhaps on dry land.

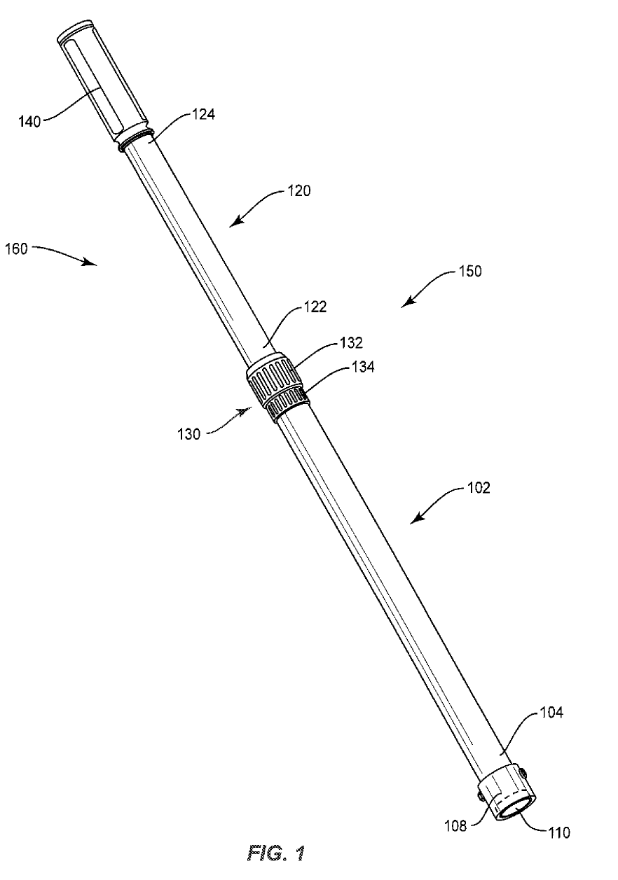

As shown in FIG. 1, magnetic retrieval device 150 includes a rod 160 which is longitudinal in shape and includes a handle 140 on a proximal end 124 and magnet 110 on a distal end 104 of rod 160. Rod 160 may be made from, for example, a material that is conductive or nonconductive such as a wood, a metal or a plastic, a metal or wood coated with a plastic, a metal coated with a foam, or any mixtures thereof. In some applications, it is preferred that the device has enough weight that it will aid in its own navigation, through gravity, through a fluid or into a visually obstructed location. In such applications, rod 160 made of a heavy material such as a metal. In other applications, such as capturing debris from an elevated location, a device that is light may be preferred and in such applications a retrieval member that is light may be used such that the device will be easy to lift and navigate. In such embodiments rod 160 comprises a light material such as a plastic or aluminum.

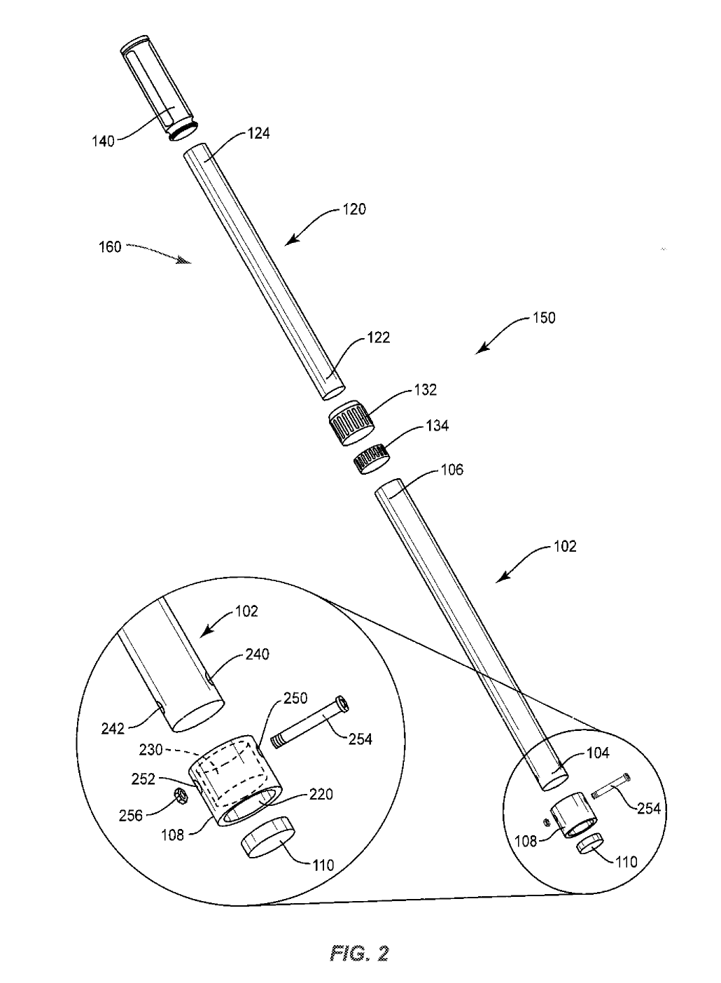

As illustrated in FIG. 2, which depicts an exploded view of magnetic retrieval device 150, rod 160 may be divided into two separate rods that are attached together. For example, first sectional rod 102 may be connected to second sectional rod 120. First and second sectional rods 102 and 120 may be connected to each other by extendable coupling mechanism 130. Extendable coupling mechanism 130 includes a rotatable piece 132 and a fixed piece 134. Rotatable piece 132 may have a closed and opened position based on rotating rotatable piece 132 about an axis. In the closed position, rotatable piece 132 is tight against fixed piece 134, which causes a clamp (not shown) inside extendable coupling mechanism 130 to secure first and second sectional rods 102 and 120 in place. In the opened position, rotatable piece 132 is loose with respect to fixed piece 134, thereby causing the clamp to loosen as well. In this regard, the opened position allows first and second sectional rods 102 and 120 to extend relative to each other, thereby extending rod 160 as a whole. Rod 160 may extend accordingly depending on the overall size of magnetic retrieval device 150.

As a further example, first and second sectional rods 102 and 120 may be coupled to each other via a male and female coupling, such as, for example, where both pieces have different internal diameters. Coupling may also be by female to female coupling such as where the internal or external diameter end of one sectional rod is the same as the internal or external diameter of the end of the other sectional rod. Where the diameters are the same, the female to female coupling may be facilitated by external coupling members (e.g., male to female). The coupling may also be made by a screw coupling where a screw is provided that secures one sectional rod to another. As another example, the coupling is a hole-in-button coupling wherein at least one hole is provided in sectional rod and at least one depressible button is provided in the other sectional rod such that the at least one button fits into the at least one hole and is depressible therefrom to terminate the coupling. It is contemplated herein that one sectional rod may be made from one material or composition of material that is different from the other sectional rod, or both sectional rods may be comprised of the same materials. It should be noted, however, that rod 160 may be one whole piece or divided into any number of sections, such as described above with respect to first and second sectional rods 102 and 120. In addition, rod 160 may be divided into three pieces, four pieces, etc.

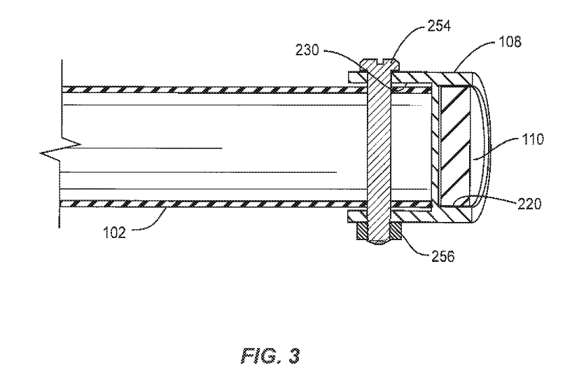

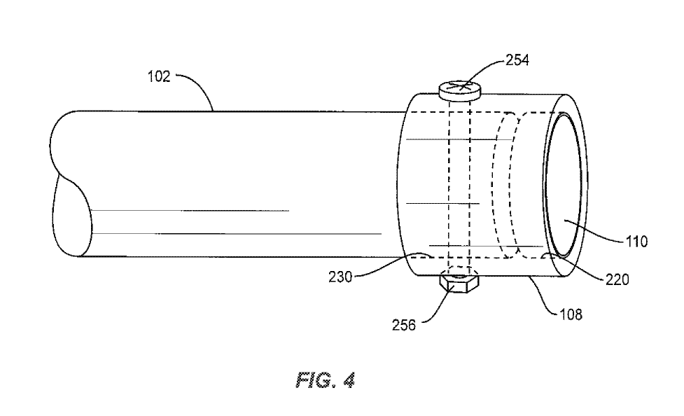

As shown in FIGS. 2-4, rod 160 is connected to a first recess 230 of cover 108. For instance distal end 104 of rod 160 may have a diameter that is slightly smaller than the diameter of cover 108 surrounding first recess 230. In this regard, distal end 104 of rod 160 is capable of fitting into first recess 230. As one example, distal end 104 of rod 160 may securely couple to first recess 230 by having at minimum a frictional force that obstructs separation of rod 160 from first recess 230. For example, where rod 160 is securely coupled to first recess 230, the outer diameter of rod 160 is placed within an inner diameter (or vise versa) of first recess 230, thereby creating a friction between the two components. In addition or alternatively, when rod 160 is placed within first recess 230, a bolt 254 may extend through aligned bores 250 and 252 on cover 108 and bores 240 and 242 on rod 160 as depicted in FIG. 2. Bolt 254 may then be secured in place by a nut 256 on a side of cover 108 opposite bolt 254, as illustrated in FIGS. 3 and 4. Alternatively, rod 160 may attach to cover 108 via other fastening means as well, including a tab and notch mechanism, wherein a tab positioned on rod 160 inserts into a notch on cover 108, or vise versa. As another example, rod 160 may screw into cover 108 via threaded components, such as first recess 230 and distal end 104 of rod 160 may be threaded. Multiple fastening means described above may be used together as well, such as a tab and notch and threaded mechanisms may be used to attach rod 160 to cover 108. Any other combination of the fastening means described above is possible.

Cover 108 is also connected to magnet 110 via a second recess 220 that receives magnet 110. Magnet 110 may be any type of magnet, including a temporary magnet, permanent magnet, or electromagnet. In addition, the shape of the magnet 110 may be determined based on the shape of second recess 220, which receives magnet 110. In this regard, although a circular magnet 110 and second recess 220 is depicted in the figures, any shape may be selected, including rectangular or triangular. The shape of magnet 110 may or may not correspond to the shape of second recess 220.

Second recess 220 may be on a side of cover 108 opposite first recess 230. Alternatively, however, magnet 110 may be positioned at any location of cover 108. For instance, as depicted in FIGS. 2-4, magnet 110 is aligned with rod 160; however, magnet 110 may be off-base with rod 160, such as on a diagonal angle. As another example, magnet 110 may be positioned on the side of bolt 254 or nut 256. As a further example, multiple magnets may be used, such as one magnet positioned on the same side as bolt 254, one magnet positioned on the same side as nut 256, one magnet positioned on the same side as recess 220, or any combination thereof.

As illustrated in FIGS. 1-5, magnet 110 is received in second recess 220 of cover 108. In this regard, magnet may be secured in second recess 220 of cover 108 similarly as described above with respect to rod 160 entering first recess 230 of cover 108. For instance, magnet 110 may securely couple to second recess 220 by having at minimum a frictional force that obstructs separation of magnet 110 from second recess 220. For example, where magnet 110 is securely coupled to second recess 220, the outer diameter of magnet 110 is placed within an inner diameter (or vise versa) of second recess 220, thereby creating a friction between the two components. In addition or alternatively, when magnet 110 is placed within second recess 220, a bolt and nut mechanism may be implemented, similar to rod 160 connecting to cover 108 via bolt 254 and nut 256. Alternatively, magnet 110 may attach to cover 108 via other fastening means, including a tab and notch mechanism, wherein a tab positioned on magnet 110 inserts into a notch on cover 108, or vise versa. As another example, magnet 110 may screw into cover 108 via threaded components, such as second recess 220 and an end of magnet 110 may be threaded. As a further example magnet 110 may be permanently welded or glued to second recess 220. For instance, magnet 110 may be connected to second recess 220 by an adhesive that adheres a proximal side of the magnetic means, its circumferential sides or both to the surface area of the second recess. Suitable adhesives are known to those of skill in the art.

Furthermore, cover 108 may not have second recess 220; rather, magnet 110 may attach to a flat surface of cover 108 by any of the methods described above with respect to magnet 110 and second recess 220. Multiple fastening means described above may be used together as well, such as a tab and notch or threaded mechanisms may be used to attach magnet 110 to cover 108. Any other combination of the fastening means described above is also possible. In addition, second recess 220 may be shallow enough such that a distal face of magnet 110 is flush with the distal end of the second recess or flush with distal end 104 of rod 160.

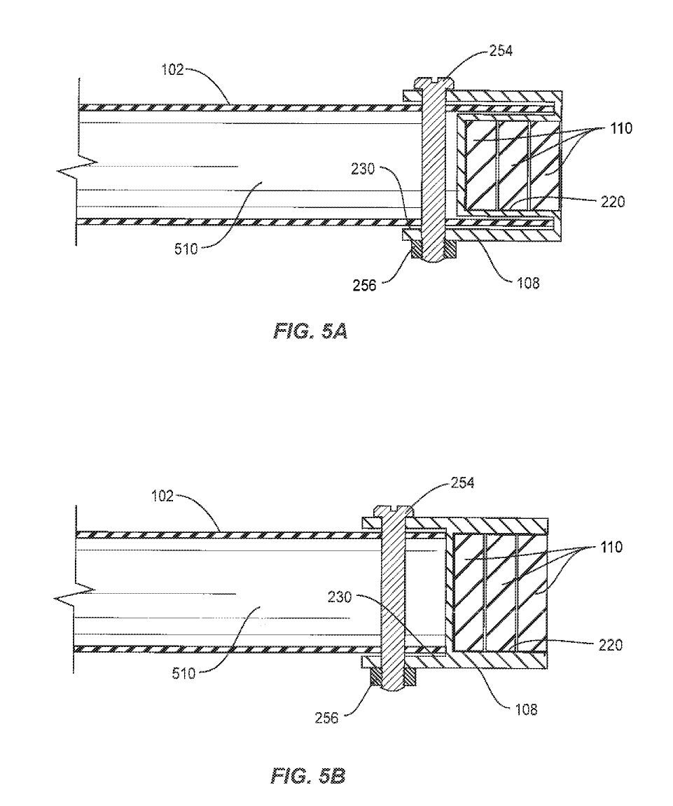

In another embodiment and as illustrated in FIG. 5A, second recess 220 may extend into a lumen 510 of rod 160. In this regard, rod 160 may be hollow on the inside, in which case the hollow portion of rod 160 forms lumen 510. Magnet 110 may be set inside lumen 510 at a position away from cover 108. It should be noted, however, that rod 160 may be hollow or solid on the inside thereof. Alternatively, as shown in FIG. 5B, second recess 220 of cover 108 may extend outward away from rod 160. In this scenario, recess 220 does not enter lumen 510. It should be noted, however, that if second recess 220 of cover 108 extends outward away from rod 160, second recess 220 may still enter lumen 510 as well.

When magnet 110 is used as a retrieval device, a user may attract objects that are affected by magnet 110, such as metallic objects. Metallic objects may include bottle tops, coins, keys, women's hair barrettes and bobby pins, watches and other jewelry, soda cans, etc. In this regard, when magnet 110 is placed near the particular object, such as a bottle top, the bottle top will cling to magnet 110. At this point, the user can pull distal end 104 close to himself or herself in order to gather the bottle top and any other objects that clinged to magnet 110. The ability to attract debris to magnet 110 may allow a user to clean up debris in various locations, including if a drain is clogged or if debris is located out of reach from the user's hand.

As another example, when second recess 220 is deep enough such that there is empty space above magnet 110, magnet 110 may retrieve objects within the diameter of lumen 510. This way, any objects that are caught, such as the bottle top or jewelry, are encased within surrounding walls formed by second recess 220 and/or lumen 510. This may help prevent the caught objects from falling off magnet 110 when rod 160 begins to move around, such as by knocking into another tangible object or perhaps by the sheer speed and movement of rod 160.

As illustrated in FIGS. 5A-B, magnet 110 may be positioned at multiple levels within second recess 220. The positioning of magnet 110 may depend on the overall size of second recess 220. As another example, magnet 110 may be re-positionable within second recess 220, such that a user may position magnet 110 at a bottom of second recess 220, halfway into second recess 220, at a top of second recess 220, or at any level therebetween. The level a user positions magnet 110 may depend on what debris the user wants to pick-up. For instance, for a larger object that fits within second recess 220 a user may want to position magnet 110 at a bottom of second recess 220. If the user has a lot of debris they want to pick-up, they may position magnet 110 near the bottom of second recess 220 as well. Alternatively, if the user thinks the force of the magnet will not reach the debris by being near the bottom of second recess 220, then the user may position magnet 110 nearer to or at the end of cover 108.

As an additional embodiment, magnet 110 may be adjustable upon a joint (not shown) on an end of rod 160 or cover 108. For instance, cover 108 as depicted in the figures is in a fixed position. However, a joint may be positioned where cover 108 is on magnetic retrieval device 160 which allows magnet 110 to face various directions. In this regard, instead of magnet 110 facing in one longitudinal direction, the joint allows magnet 110 to face directions within a range. For instance, the joint may allow magnet 110 to face toward bolt 254, nut 256, or any direction 360° around a circumference of magnet 110. The joint may allow magnet 110 to form right angles or face diagonally. In this regard, multiple joints may be used to permit magnet 110 to change directions. Alternatively, a ball and joint may be implemented to allow magnet 110 to face various directions.

As another embodiment, there may be multiple retrieving magnets implemented on distal end 104 of rod 160 that can be easily switched by the user. For example, in a first mode a first retrieval magnet can be exposed to the outside and in a second mode the second retrieval magnet can be exposed to the outside. In this regard, the magnet may be attached to a two sided piece, on one side of the piece the first retrieval magnet is attached and on a second side of the piece the second retrieval magnet is attached. The piece may be attached to rod 160 via a bolt and screw, tab and notch, or other fastening means. The piece may rotate about an axis and lock into place when in two positions, each position exposing either the first or second retrieval magnet. The user may be able to switch which side they want by, for example, rotating the piece to the side they want. Alternatively, the piece may be removed, flipped around and then put back in place. As another alternative, a single magnet may be used in which two of the sides can be the first and second retrieval magnets.

The above disclosure is advantageous in that magnetic retrieval device 160 allows a user to remove metallic and other types of debris in an easy manner. Instead of a user having to attempt to use a skimmer or his or her hands to retrieve debris, the user is able to use magnetic retrieval device 160. In addition, when the debris is located in hard to reach or visually observe locations, the user is able to use the magnetic retrieval device to extend and retrieve. In addition, since magnetic force extends beyond the physical magnet itself, hard to reach debris and objects becomes even easier to reach. In addition, magnet 110 of magnetic retrieval device 160 has a broader targeting area than traditional mechanical retrieval devices while maintaining a narrow focal point. Other mechanical retrieval devices may include a pool skimmer or a sharp point. Accordingly, less material is needed in order to facilitate the capturing of debris, which improves costs. Additionally, less precision is required which reduces effort and increases efficiency in capturing a targeted object or debris.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

1. A magnetic retrieval device, comprising:
a rod having a distal end and a proximal end; and
a magnet attached to the distal end of the rod.

2. The magnetic retrieval device of claim 1, wherein the proximal end and the distal end are connected by the rod, wherein the rod is a lumen.

3. The magnetic retrieval device of claim 1, further comprising a cover on the distal end of the rod, wherein the magnet is positioned inside a recess of the cover.

4. The magnetic retrieval device of claim 3, further comprising a fastening means for attaching the cover to the rod.

5. The magnetic retrieval device of claim 3, wherein a depth of the recess does not extend beyond the distal end of the rod.

6. The magnetic retrieval device of claim 3, wherein the rod is a lumen, and a depth of the recess extends into the lumen.

7. The magnetic retrieval device of claim 3, wherein the magnet is positionable at multiple positions within the recess of the cover.

8. The magnet retrieval device of claim 7, wherein the magnet is positioned at a bottom of the recess, thereby creating a receivable space surrounded by walls of the recess of the cover to encase objects that are received inside the receivable space.

9. The magnetic retrieval device of claim 1, wherein the magnet comprises at least one of a permanent magnet, a temporary magnet or an electromagnet.

10. A retrieval device to clean debris in a pool, comprising:
a rod having a distal end and a proximal end;
a cover attached to the distal end of the rod; and
a fastening means for attaching a magnet to the cover.

11. The retrieval device of claim 10, wherein the fastening means includes the magnet being positioned within a recess of the cover, wherein surrounding walls that form the recess extend in a direction away from the rod.

12. The retrieval device of claim 11, wherein the recess of the cover does not extend beyond the distal end of the rod.

13. The retrieval device of claim 11, wherein the recess of the cover extends into a body of the rod.
